(19) United States
(12) Patent Application Publication
(10) Pub. No.: US 2025/0093667 A1
(43) Pub. Date: Mar. 20, 2025

(54) ELECTRONIC CONNECTOR

(71) Applicant: Apple Inc., Cupertino, CA (US)

(72) Inventors: Josiah C. Frye, Bothell, WA (US); Ibuki Kamei, Santa Clara, CA (US); John Raff, Menlo Park, CA (US); Varun K. Sanghvi, San Francisco, CA (US)

(21) Appl. No.: 18/892,132

(22) Filed: Sep. 20, 2024

Related U.S. Application Data
(60) Provisional application No. 63/583,944, filed on Sep. 20, 2023.
(60) Provisional application No. 63/608,602, filed on Dec. 11, 2023.

(51) Int. Cl. G02B 27/01; H01R 13/02; H01R 13/631; H01R 43/00

(52) U.S. Cl. CPC G02B 27/0176; H01R 13/02; G02B 2027/0178; H01R 13/631; H01R 43/002

(57) ABSTRACT

A head-mountable device can include a frame, a window secured to the frame, and a securement arm. The securement arm of the device can include a proximal end secured to the frame, and a distal tip opposite the proximal end. A waveguide can be disposed in the securement arm and configured to direct light displayed at the window. Furthermore, an electronic port can be disposed at the distal tip and can also be electrically coupled to the waveguide.

### CROSS-REFERENCE TO RELATED APPLICATION

This application claims the benefit of U.S. Provisional Patent Application No. 63/583,944, filed 20 Sep. 2023, and entitled “ELECTRONIC CONNECTOR,” and also claims the benefit of U.S. Provisional Patent Application No. 63/608,602, filed 11 Dec. 2023 and entitled “ELECTRONIC CONNECTOR,” the entire disclosures of which are hereby incorporated by reference.

### FIELD

The examples of the present disclosure relate generally to electronic devices. More particularly, the examples of the present disclosure relate to head-mountable electronic devices.

### BACKGROUND

Various components of head-mountable electronic devices, such as display screens, viewing frames, securement arms, speakers, batteries, waveguides, and other components, operate together to provide an immersive and comfortable experience. Operation of these devices can require a connector for an external attachment. This attachment can be used for various purposes, such as for charging the device and any other purpose for the benefit of the user. The attachment can also be configured to be used while a user is operating the head-mountable device. However, the anatomy of each user's head is unique. One user's ears can be a different size than another. The distance between the front of a user's head and their ear, as well as the distance between a user's ear and the back of their head can vary. Other anatomical features, including relative positions of a user's nose, forehead, eyes, as well as features such as hair length, can also vary between users. The anatomical variety of different users presents a challenge for connectors to external attachments for head-mountable devices designed for comfort and reliability.

Additionally, head-mountable devices can be used in a variety of different settings and during a variety of different activities. These can range from lying down still in bed to mountain biking or hiking outdoors. Thus, even for a single user, the connection for an external attachment of a head-mountable device that is secure for one activity may not be secure for another activity.

### SUMMARY

Various examples of the present disclosure include a device including a frame, a window secured to the frame, and a securement arm. The securement arm of the device can include a proximal end secured to the frame, and a distal tip opposite the proximal end. A waveguide can be disposed in the securement arm and configured to direct light displayed at the window. Furthermore, an electronic port can be disposed at the distal tip and can also be electrically coupled to the waveguide.

In one example, the distal tip of the device can be configured to be disposed behind a user's ear when the user dons the device. In another example, the securement arm of the device can include a first joint between the proximal end and the frame and a second joint can be disposed between the proximal end and the distal tip.

In various examples of the present disclosure, the port can be disposed distal to the second joint, which can be an area comfortable for the user. Furthermore, the waveguide can be disposed between the first joint and the second joint. In one example, the port can include an aperture that can be defined by the distal tip of the securement arm. The distal tip can include an inner surface, which can define the aperture, wherein first and second electrical contacts can further define the inner surface.

In at least one example, a battery can be disposed in the distal tip, which, in some examples, can electrically couple the first and second electrical contacts to the waveguide. The electronic port can include a first electrical contact defining an external surface of the securement arm. The electronic port can also include a second electrical contact defining the external surface.

In some examples of the present disclosure, an electronic securement arm for a wearable device can include a housing, wherein the housing can include a proximal portion and a distal portion. In at least one example, the distal portion can be disposed at an angle relative to the proximal portion, where the distal portion can define an aperture. A battery, as well as a port, can also be disposed in the housing. Furthermore, the port can include the aperture and a contact electrically coupled to the battery, where in at least one example the contact can define the aperture. In some examples, a retention feature can also define the aperture, where the retention feature can enable the user to perform a variety of activities while donning the device connected to an external attachment.

In various examples of the present disclosure, the aperture of the electronic securement arm can be defined by a through-hole extending entirely through the distal portion. In some examples, the port can include a data entry port, and in some examples, the port can include a power port. In at least one example, the distal portion can include an inner surface defining the aperture. The inner surface can also define a detent, wherein the retention feature can also include the detent. In some examples, a first electrical contact and a second electrical contact can define the inner surface of the distal portion.

In some examples of the present disclosure, a smart glasses arm can further include a distal tip, an electronic component disposed in the distal tip, and an electronic port disposed at the distal tip. In one or more examples, the electronic port can include a selectively translatable electrical contact, wherein the selectively translatable electrical contact can include an open configuration including the electrical contact exposed to an external environment and a closed configuration including the electrical contact being inaccessible and disposed within the distal tip.

In at least one example, the electronic port can include a first portion having a first diameter, and a second portion having a second diameter less than the first diameter. The first portion can define an external surface of the distal tip in the closed configuration. In at least one example, the second portion can also include the electrical contact.

In at least one example of the present disclosure, the electronic port of the smart glasses arm can be configured to be manually operable between the open configuration and the closed configuration. In one example, the electronic port can include a magnet. In one example, the electronic port can also be magnetically operable between the open configuration and the closed configuration. In at least one example, a ferrous component can also be disposed in the distal tip, which can bias the electronic port in the closed configuration via the magnet.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top-down view of an example of an electronic connector;

FIG. 2A illustrates a side-view of an example of an electronic connector;

FIG. 2B illustrates another side-view of an example of an electronic connector in relation to the head of a user;

FIG. 3 illustrates a sequence of connections and components within the electronic connector;

FIG. 4 illustrates a side-view thereof, illustrating an example of an electronic port, according to the present disclosure;

FIG. 5 illustrates a perspective-view of an example of a port attachment, according to the present disclosure;

FIG. 6A illustrates a cross-sectional side-view of an example of a selective port in a closed position;

FIG. 6B illustrates a cross-sectional side-view of an example of a selective port in an open position;

FIG. 6C illustrates a side-view of an example of a selective port in an open position;

FIG. 7 illustrates a perspective view of an example of a port attachment, according to the present disclosure;

FIG. 8 illustrates a side-view of an example of a port attachment, according to the present disclosure;

FIG. 9 illustrates a cross-sectional side-view example of the union of an electronic port and attachment, according the present disclosure;

FIG. 10 illustrates a cross-sectional side-view example of the union of an electronic port and attachment, according to the present disclosure;

FIG. 11A illustrates a cross-sectional side-view example of another electronic port and attachment, according to the present disclosure; and

FIG. 11B illustrates another side-view and top view of the electronic port attachment of FIG. 11A;

FIG. 12 illustrates a cross-sectional side-view example of another electronic port, according to the present disclosure;

FIG. 13A illustrates a cross-sectional side-view example of another electronic port attachment; and

FIG. 13B illustrates another configuration of the electronic port attachment of FIG. 13A; and

FIG. 14 illustrates a cross-sectional side-view example of the electronic port attachment of FIG. 13A inserted into the electronic port of FIG. 12, according to the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure generally relates to electronic devices. More particularly, the present disclosure relates to head-mountable electronic devices. In at least one example, a head-mountable electronic device can include a frame and a securement arm extending from the frame. The securement arm can include a power port and/or data port positioned at a distal end or tip of the securement arm behind a user's ear during use. Examples of head-mountable devices can include optical devices (e.g., glasses, transparent windows, etc.) or virtual/augmented reality devices that can include an optical component. In these cases, the head-mountable device can be worn on the head of a user such that optically transparent widows, for example lenses and transparent optical displays, can be positioned in front of a user's eyes. Other electrical components for the powering and operation of the device can also be disposed in the device, for example batteries and waveguides. The electronic port disposed distally on the securement arm can be electrically coupled to the various other electronic components of the device to provide a connection point for data or power cables.

Current wearable devices can include port connections at locations designed for use when the user is not wearing the device and/or where data or power cables interfere with the experience of the user and create discomfort during use. The securement arms of a head-mountable device described herein are designed for comfort and securement during long-term use. Any electrical component, including electrical ports and other components mentioned herein, which may be placed in or on the securement arm itself, can be designed and placed strategically to avoid interfering with the weight distribution, securement forces, comfort, and/or field of view of the device and the user, enabling in-use data and power connections.

As noted above, in a particular example, the electronic port is disposed at the distal tip of the securement arm, wherein the electronic port can be electrically coupled to the electronic components disposed in the device. In some examples, the distal tip of the securement arm can be disposed behind a user's ear when the user dons the head-mountable device. This can enable the user to comfortably connect external attachments to the electronic port while operating the device.

In at least one example, connecting an external attachment through the electronic port can assist with charging and/or data entry during operation of the device. This can enable the user to operate the device for an extended period of time, among other advantages.

In some examples, the distal tip of the securement arm can be defined by an aperture, wherein the electronic port can include electrical contacts that define the inner surface of the aperture. In a particular example, the aperture can be a through-hole extending entirely through the distal portion. In this example, the aperture and an external attachment can be configured with retention detents that can hold the attachment in place while the user operates the device. This can enable the user to perform various activities while operating the head-mountable electronic device.

In a particular example, the electronic port can include a selectively translatable electrical contact that can be manually or magnetically configured into closed and open positions. The open position can include the electrical contacts of the electronic port being exposed to an external environment. The closed position can include the electrical contacts being inaccessible and disposed within the distal tip of the device, and the first portion can lie flush with the surface of the securement arm. This configuration can enable the device to prevent unwanted materials from interfering with the electrical contacts, such as the user's hair, clothing, moisture, and so forth.

The physical design and distal position of the electronic port on the securement arm of a head-mountable device allows a user to connect to data and power sources while using the device while enhancing comfort and minimizing interference from the cables or connection. Accordingly, the examples of electronic ports and connectors in the present disclosure can provide the user with secure and comfortable methods of connecting external attachments to head-mountable devices.

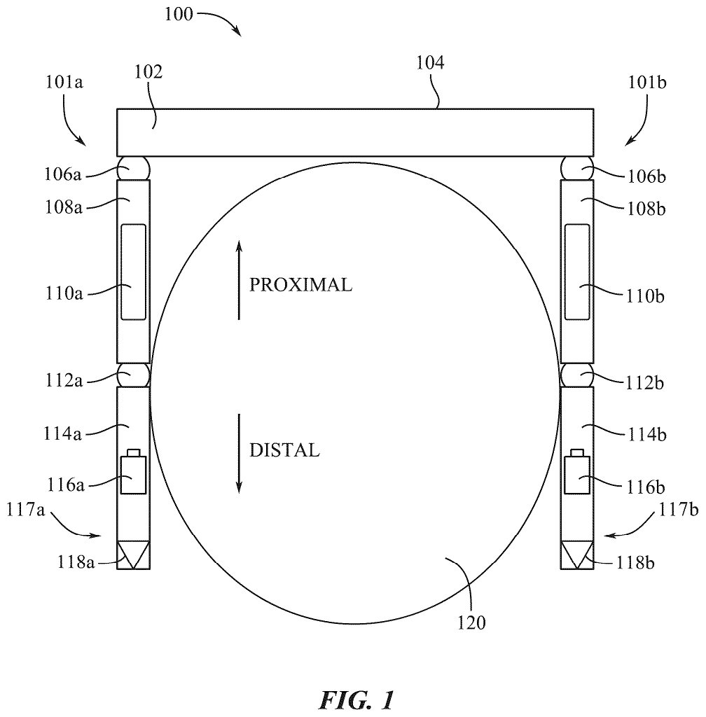

These and other embodiments are discussed below with reference to FIGS. 1-11B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top-down view of an example of a head-mountable electronic device 100. The head-mountable electronic device 100 can be any device or system configured to be worn on the head 120 of the user, such as a head-mountable electronic device, an optical device, smart glasses, alternate/virtual reality goggles, and the like. As shown in FIG. 1, the device 100 can include a viewing frame 102, which can house a variety of components and systems. In at least one example, the viewing frame 102 can be configured to secure one or more optically transparent windows 104, for example transparent material, optical lenses, or transparent display screens, in front of the eyes of the user. According to the example shown in FIG. 1, at least one of the securement arms 101a and 101b can be attached to the viewing frame 102. Securement arms 101a and 101b can include proximal ends 108a and 108b, which can be attached to the viewing frame 102, with distal ends 114a and 114b further extending from the proximal ends 108a and 108b, respectively.

In at least one example, the securement arms 101a and 101b can include a first joint 106a, 106b. The first joints 106a and 106b can be placed between the proximal ends 108a, 108b of the securement arms 101a, 101b and the viewing frame 102. According to the example of FIG. 1, the securement arms 101a and 101b can also include second joints 112a and 112b, which can be located between the proximal ends 108a, 108b, and the distal ends 114a, 114b of the securement arms 101a, 101b. The combination of the first and second joints 106a, 106b, 112a, and 112b can be advantageous to the user in that the device 100 can better conform to a wide variety of user head and face sizes and shapes. Better conformity to different sizes and shapes can result in greater comfort felt by a wide range of users wearing the device 100, as well as enabling sufficient retention when the user moved while donning the device 100.

FIG. 1 also illustrates the use of other components that can be housed inside the securement arms 101a and 101b. In at least one example, the securement arms 101a and 101b can house a variety of different components including, but not limited to, electronic components 110a, 110b. The electronic components 101a-b can include one or more projectors, waveguides, processors, speakers, and so forth. Other electronic components can be included with the securement arms 101a-b, including batteries 116a and 116b and electronic ports 118a and 118b. In examples where the electronic components 110a-b include one or more projectors and/or waveguides housed in at least one of the securement arms 101a and 101b, the projectors and waveguides can be configured to direct light displayed at the window 104 attached to the viewing frame 102.

In at least one example, a battery 116a, 116b can also be housed in at least one of the securement arms 101a and 101b. The use of batteries 116a and 116b can be advantageous to the user of the device 100 in that it can extend usage time. Batteries 116a and 116b can allow the user to operate the device 100 without having to frequently interrupt operation to charge device 100, therefore increasing productivity and efficiency of use for the user.

In at least one example, electronic ports 118a and 118b can be disposed on or in at least one of the securement arms 101a and 101b. In some examples, the electronic ports 118a and 118b can be disposed at the distal tips 117a and 117b of the distal ends 114a and 114b of the securement arms 101a and 101b. The distal tips 117a and 117b can be defined as a portion or section of the securement arm 110a-b configured to be disposed behind the ear of the user when the device 100 is donned. In some examples, depending on the dimensions of the user's face and head, the distal tips 117a-b include about 30% or less of a total longitudinal length of the securement arms 110a-b between the proximal end of the securement arms 101a-b to a distal end of the securement arms 101a-b. In one example, the distal tips 117a, 117b, can include about 20% or less of the total longitudinal length of the securement arm 101a-b, or about 10% of the longitudinal length of the securement arms 101a-b. The electronic ports 118a and 118b can enable the user to easily access to charging capabilities while operating the head-mounted electronic device.

Any of the features, components, and/or parts, of the rim 360 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

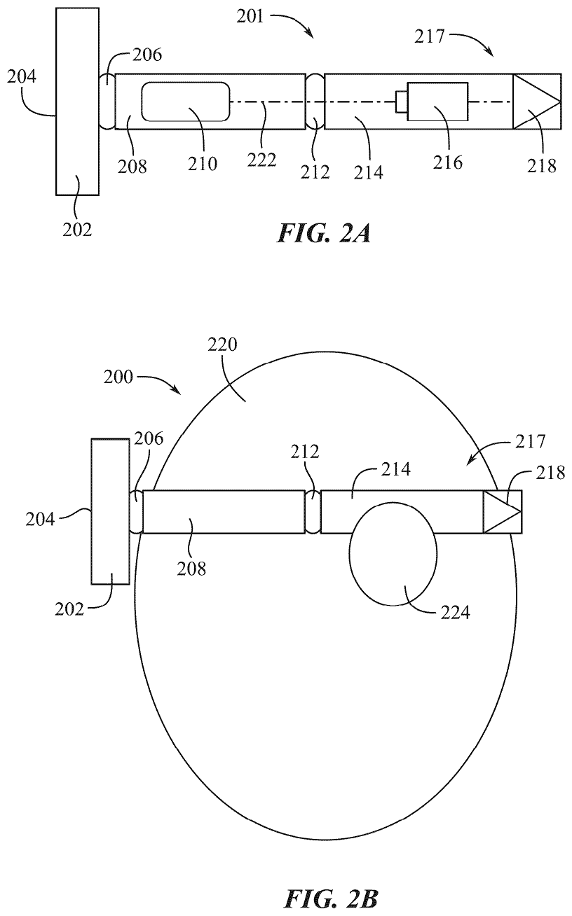

FIGS. 2A and 2B show a side view of an example of a head-mountable electronic device 200. In at least one example, one or more optically transparent windows 204 can be secured to the viewing frame 202 of the device 200. A securement arm 201 can also be attached to the viewing frame 202. As shown in FIG. 2A, a securement arm 201 can be separated into different sections. For example, the securement arm 201 can include a proximal section or portion 208 and a distal section or portion 214, where the proximal portion 208 can be attached to the viewing frame 202 by a first joint 206. In at least one example, a second joint 212 can join the proximal portion 208 with the distal portion 214. In some examples, the combination of the first joint 206, the proximal portion 208, the second joint 212, and the distal portion 218 can form a single structure for a securement arm 201 of the device 100.

In at least one example, the securement arm 201 can house a variety of different electronic components 210, including but not limited to one or more waveguides and/or projectors. One or more other electronic components, including a battery 216 and an electronic port 218. According to the example of FIG. 2A, the electronic component 210 can be disposed between the first and second joints 206 and 212. Disposing the electronic component 210 in the proximal end 208 of the securement arm 201 can be advantageous in that the proximal end 208 of the securement arm 201 is closer in proximity to the at least one optically transparent window 204. In examples where the electronic component includes one or more projectors or waveguides, the proximal location thereof can enable the projectors and/or waveguides to efficiently direct light to the desired target and enhance the operation of the device 100 for the user.

In at least one example, a battery 216 can be disposed with the distal portion 214. The placement of the battery 216 in the distal portion 214 can allow ample space for the waveguide 210 in other parts of the securement arm 201, such as within the proximal portion 208. In addition, the distal portion 214 can include a distal tip 217 of the securement arm 201. In one example, the distal tip 217 includes 30% or less of a total length of the securement arm 201 at the distal end thereof such that the distal tip 217 is disposed behind the user's ear when donned. In some examples, the distal tip includes less than 20%, less than 10% or less than 5% of the distal most length of the securement arm 201. In at least one example, the electronic port 218 is disposed at or with the distal tip 217 of the securement arm 201.

As shown in FIG. 2A the waveguide 210, battery 216, and the electronic port 218 can be connected via an electrical circuit 222. In some embodiments, the electrical circuit 222 can be configured to connect components throughout the device 100. The electrical circuit 222 can connect components through the proximal end 208 and the distal end 214, along with the first joint 206 and second joint 212 of the securement arm 201. The electric circuit 222 can also be configured to connect components disposed in the viewing frame 202 of the device 100. For example, electrical charge input to the device 100 via the electronic port 218 can be fed to the battery 216. The charge stored in the battery 216 can then be connected to power the electronic components 210.

As shown in FIG. 2B, the device is configured to be donned by a user. When worn on a user's head 220, the device 100 can be placed in any number of ways, one of which being where the securement arm 201 can rest on top of the user's ear 224. In this position, the distal end 214 of the securement arm can be set to rest above the user's ear 224.

In at least some examples, the distal end 214 above the user's ear 224 can cause the distal tip 217 to be disposed behind the user's ear 224. The distal tip 217 of the securement arm 201. In one example, the distal tip 217 includes 30% or less of a total length of the securement arm 201 at the distal end thereof such that the distal tip 217 is disposed behind the user's ear when donned. In some examples, the distal tip includes less than 20%, less than 10%, or less than 5% of the distal most length of the securement arm 201. The electronic port 218 can be disposed at the distal tip 217 of the securement arm 201. The distal tip 217 is an easily accessible area of the securement arm 201 disposed behind the user's ear where the user can connect external attachments without disrupting other functions of the device 100, including securement functions of the securement arms 201 and display functions of the viewing frame 202. Adding external attachments behind the user's ear 224 can keep the user's field of view free where it could otherwise have a negative impact on the user's experience. The distal position of the electronic port 218 at the distal tip 217 of the securement arm 201 can also provide easy access for connecting exterior attachments to the device 100 without interfering with the user or the overall functionality.

Any of the features, components, and/or parts, of the rim 360 including the arrangements and configurations thereof shown in FIGS. 2A and 2B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A and 2B.

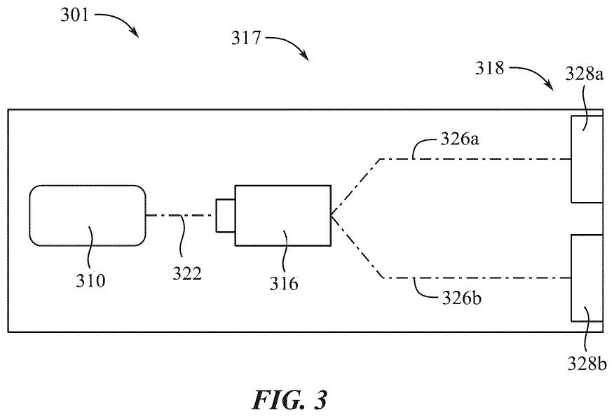

FIG. 3 shows a side-view of an example of a securement arm 301. In at least one example, the securement arm 301 can house any number of components. These components can include, but are not limited to, a projector 310, a waveguide, a battery 316, and an electronic port 318. The various components can be connected via an electrical circuit 322. In some examples, the electronic port 318 can include a system of at least a first and second electrical contact 328a and 328b. The first and second electrical contacts 328a and 328b can be externally exposed and can be accessed from outside the securement arm 301. In at least one example, the at least first and second electrical contacts 328a and 328b can be connected to the electric circuit 322 by the use of contact circuits 326a and 326b. In at least one example, the battery 316 can electrically couple the contact circuits 326a and 326b to the waveguide 310. In some embodiments, the battery 316 can be disposed in the distal tip 317.

In at least one example, the electronic port 318 can be used to perform different types of functions. In some examples, the electronic port 318 can include a power port. The power port can enable charging of the device of which the securement arm 301 is a part. In at least one example, the port 318 can also include a data entry port. The data entry port can enable the device to receive instructions, updates, and like information from an exterior source. In examples where the port 318 includes a data entry port, the electrical contacts 328a-b can be electrically coupled with one or more processors, memory components, or other components connected via the circuits 326a-b.

Any of the features, components, and/or parts, of the rim 360 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

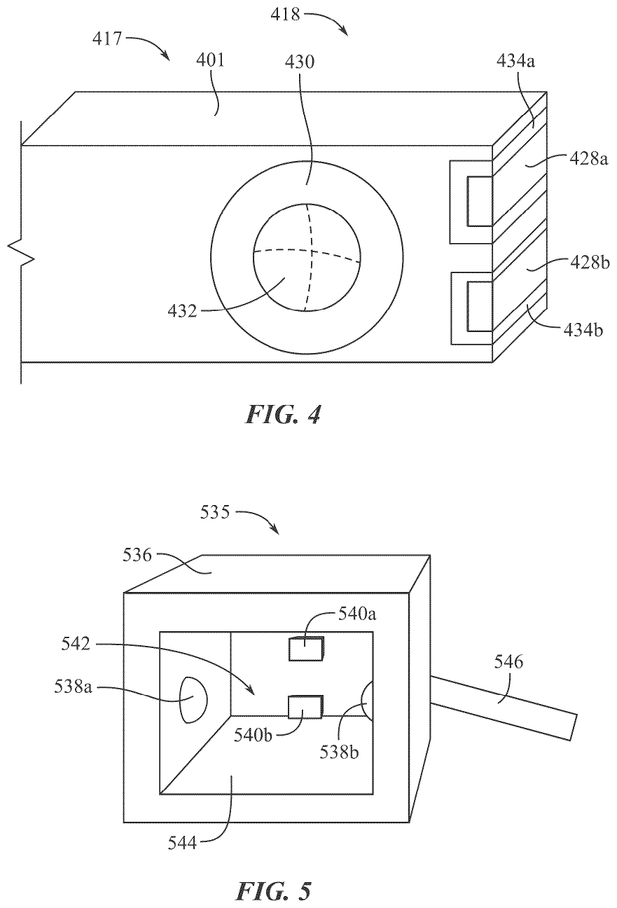

FIG. 4 shows a perspective view of a slip-over port 418. The slip-over port 418 can be located at the distal tip 417 of the securement arm 401. The slip-over port 418 can include various configurations to accept a variety of different external attachments. In at least one example, the slip-over port 418 can include a retention feature, for example a retention indent 432. The retention indent 432 can recede into the body of the securement arm 401 to accept a variety of different external retention devices with complimentary features configured to mate with the retention indents 432 and mechanically lock attachments thereto via friction fits. In other examples, the retention features can be convex protrusions 432 extending away from the arm 301 to accommodate complimentary indents of external attachments. The retention indent 432 can be surrounded by a retention material 430. This retention material 430 can include the same material as the securement arm 401 or can differ from the base material of the securement arm 401 to maximize attachment retention or ease of access for different external devices.

In at least one example, the slip-over port 418 can include at least first and second electrical contacts 428a and 428b. The electrical contacts 428a and 428b can be disposed on the external surface of the securement arm 401. In one example, this configuration can allow the electrical contacts 428a and 428b to be easily accessible to a variety of different external devices. In at least one example, the electrical contacts 428a and 428b can be surrounded by insulators 434a and 434b. The insulators 434a and 434b can contain the charge received by the electrical contacts 428a and 428b. This can be advantageous to the device in that the electrical charge from electrical contacts 428a and 428b can be prevented from being distributed across the securement arm 401, regardless of the base material used.

Any of the features, components, and/or parts, of the rim 360 including the arrangements and configurations thereof shown in FIG. 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

FIG. 5 illustrates a perspective view of an example of a slip-over external attachment 535 configured to electrically couple to the slip-over port 418 shown in FIG. 4. In one example, the slip-over external attachment 535 can include an outer casing 536. The outer casing 536 can define a case aperture 542. The case aperture 542 can be various sizes in various examples to correspond to the size of the distal tip 417 of the arm 401 shown in FIG. 4. In one example, an inner aperture surface 544 can include of the same material as the outer casing 536 or a different material in other examples. In at least one example, the case aperture 542 can define a width and height that is greater than the width and height of the slip-over port 418. This configuration can be advantageous to the device 100 in that the slip-over external attachment 535 can be attached to the slip-over port 418 by securing it over the distal tip of the securement arm 401.

In at least one example, the case aperture 542 of the slip-over external attachment 500 can include at least a first and second ball detent 538a and 538b. The first and second ball detents 538a and 538b can protrude from the case aperture 542. This can allow the ball detents 538a and 538b to lock into the retention indent 432 of the slip-over port 418 when slipped over the distal tip 417 of the securement arm 401, thereby retaining the external attachment 500. As noted above, in examples where the retention features shown in FIG. 4 are protrusions rather than detents, the ball detents 538a-b of the slip-over external attachment 535 can include recessed indentations corresponding to the protrusions of the slip-over port 418. This retention system can be advantageous to the user in that the device 100 can be attached to the slip-over external attachment 535 while the user is operating the device 100, thus enabling the user to move dynamically without losing the physical and electrical connections between the device 100 and the slip-over external attachment 535.

In one example, the slip-over external attachment 535 can be configured with external electrical contacts 540a and 540b. The external electrical contacts 540a and 540b can protrude into the case aperture 542. This can allow the external electrical contacts 540a and 540b to be easily accessible to the electrical contacts 428a and 428b when the slip-over external attachment 535 is connected to the slip-over port 418. Furthermore, in at least one example the external electrical contacts 540a and 540b can be electrically connected to an electric cord 546, where the electric cord 546 can be a data cord, a power cord, or a combination of both a data and power cord. In one example, when the slip-over external attachment 535 is secured to the slip-over port 418, the electrical contacts 540a-b can contact and electrically couple with the electrical contacts 428a-b of the slip-over port 418. This contact can enable electrical power or data to be transferred from the cord 546 to the various components of the head-mountable device via one or more circuitry components thereof, as described above with reference to one or more other examples.

Any of the features, components, and/or parts, of the rim 360 including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

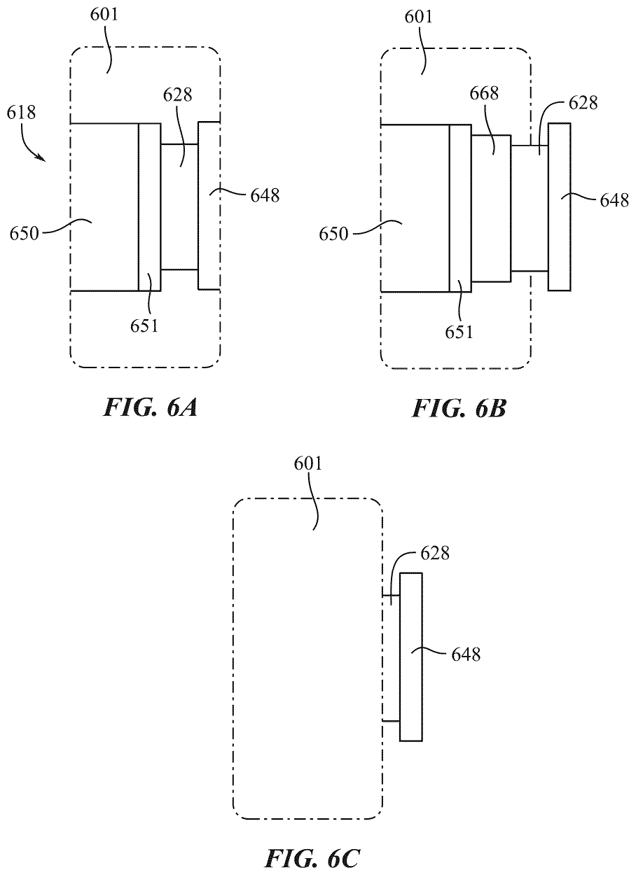

FIG. 6A illustrates a cross-sectional side-view of a selectively translatable electronic port 618 in a closed position. This selective port 618 can be configured in at least one of two ways; either through a magnetic method or a mechanical method. The magnetic method of operating the selective port 618 can be configured with a pin baseplate 650 that can be housed within the distal tip of the securement arm 601. In one example, the pin baseplate 650 can contain an attraction plate 651. The attraction plate 651 can be a magnetic component that draws leakage flux from the electric circuits contained in the device 100. For example, the leakage current from the electric circuit 322 can be used by the attraction plate 651 to induce a magnetic force that can be utilized as a retention system for the selective port 618.

In some examples, an electrical contact 628 can be radially connected to the pin baseplate 650. In some examples, a pin outer cover 648 can be radially attached to the electrical contact 628. This pin outer cover 648 can have a diameter larger than the diameter of the electrical contact 628. A larger diameter on the pin outer cover 648 can help enclose and seal off the electrical contact 628 when the selective port 618 is in the closed position. In one example, in the closed position, the pin outer cover can be flush with the surface of the securement arm 601 and can seal the electrical contact 628 from external contact, thus making it inaccessible to moisture, snagging, or other unwanted contact. The difference in diameters between the pin outer cover 648 and the electrical contact 628 can also provide a retaining feature to possible external attachments, for example, the external attachment can clip on to the pin outer cover and gain access to the electrical contact 628.

FIG. 6B shows a cross-sectional side-view of a selective port 618 in an open position. The open position, shown in FIG. 6B, as opposed to the closed position, shown in FIG. 6A, can allow the pin outer cover to protrude past the surface of the securement arm 601. This extension can also push the electrical contact 628 past the surface of the securement arm 601, making it accessible to external attachments.

In at least one example, a pin interior extension 668 can be configured to extend the electrical contact 628 and the pin outer cover 648 past the surface of the securement arm 601. In the closed position, the pin interior extension 668 can be housed inside the pin baseplate 650. In some examples, the electrical contact 628 can be constructed out of a magnetic material or contain a magnet. In the closed position, the attraction plate 651 can exert a magnetic force on the electrical contact 628 to hold the selective port 618 in a closed position, wherein the pin interior extension can be retained within the pin baseplate 650. This magnetic force can hold the selective port 618 in the closed position until it is acted upon by a stronger external magnetic force, which can bring the selective port 618 into the open position.

FIG. 6C shows an external side-view of the selective port 618 in the open position. In at least one example, the electrical contact 628 and the pin outer cover 648 can protrude from the surface of the securement arm 601. The closed position of the selective port 618 can allow the pin outer cover 648 to lie flush with the surface of the securement arm 601. This magnetic force exerted from the attraction plate 651 and the resulting retention features can be advantageous to the user of the device 100 in that the user can perform a variety of movements without the selective port 618 unintentionally moving from a closed position to an open position. This retention can further prevent unwanted materials from entering the selective port 618 or external items snagging on the device 100.

Any of the features, components, and/or parts, of the rim 360 including the arrangements and configurations thereof shown in FIGS. 6A through 6C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A through 6C.

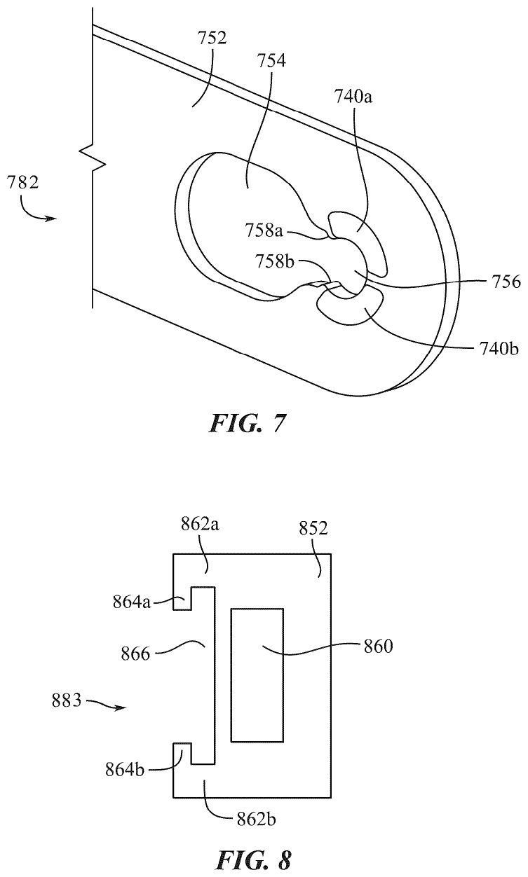

FIG. 7 shows a perspective view of an example of an attachment clip 782 for use with the port 618 shown in FIGS. 6A-6C. In one example, the attachment clip 782 can be used to clip an external device to the device 100 through use of a selective port 618. In one example, the attachment clip 782 can include an exterior clip arm 752, with the tip of the exterior clip arm 752 defined by a pin entry aperture 754. In at least one example, the pin entry aperture 754 can be configured to have a diameter and/or an area larger than the pin outer cover 648 defined in FIG. 6A. A retention funnel can be attached adjacent to the pin entry aperture 754 and the end of the retention funnel can be defined by locking ridges 758a and 758b.

FIG. 7 further illustrates, in at least one example, a pin inner aperture 756 than can be defined by a diameter less than the pin entry aperture 754 but greater than the locking ridges 758a and 758b. The pin inner aperture 756 can be configured to have a diameter smaller than the pin outer cover 648 but equal to or greater than the diameter of the electrical contact 628 as shown in FIG. 6A. In at least one example, one or more electrical contacts, including first and second electrical contacts 740a and 740b, can at least partially define the pin inner aperture 756.

In this way, the attachment clip 782 can be inserted around the open selective port 618 and the electrical contact 628 thereof can be secured within the pin inner aperture 756 so the electrical contact 628 contact the electrical contacts 740a-b thereof with the locking ridges 758a-b aiding in retention of the selective port 168. In this way, the selective port 618 can receive electrical power and/or data from the attachment clip 782 when secured together.

Any of the features, components, and/or parts, of the rim 360 including the arrangements and configurations thereof shown in FIG. 7 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 7.

FIG. 8 shows a side-view of an example of a magnetic attachment 883. In at least one example, the magnetic attachment 883 can include a magnetic clip arm 852, which can be configured to house a magnet 860. The exterior magnetic clip arm 852 can protrude along an edge to create top and bottom extension walls 862a and 862b. Furthermore, in at least one example, top and bottom retention flanges 864a and 864b can extend from both the top and bottom extension walls 862a and 862b, respectively. The combination of the magnetic clip arm 852, top and bottom extension walls 862a-b, and top and bottom retention flanges 864a-b can be configured to define a pin retention aperture 866. The pin retention aperture 866 can be configured to receive the pin outer cover 648 to attach an exterior device to the securement arm 601 of the device 100.

Any of the features, components, and/or parts, of the rim 360 including the arrangements and configurations thereof shown in FIG. 8 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 8.

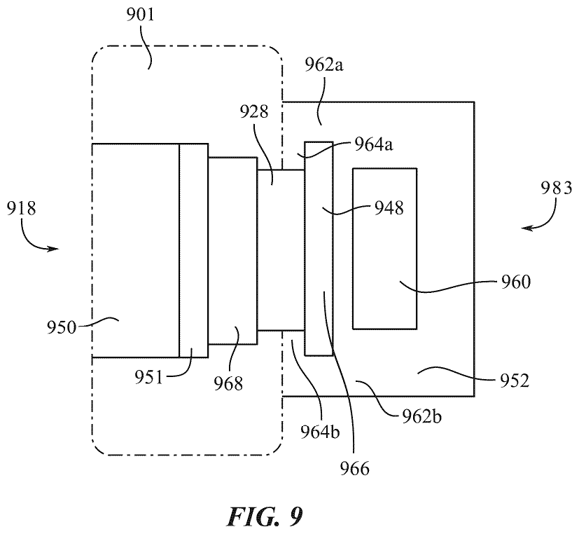

FIG. 9 shows an example of the joining of a selective port 918 and a magnetic attachment 982, which can be similar or the same as examples of the selective port 618 and the magnetic attachment 883 shown in FIGS. 6A-6C and 8, respectively. In at least one example, the magnetic clip arm 952 can be moved over the selective port 918 so as to change the selective port 918 from a closed position to an open position, as illustrated in FIGS. 6A and 6B. The positioning of the magnet 960 in close proximity to the selective port 918 can cause the electrical contact 928 to be put in reach of the magnetic forces exerted by the magnet 960, wherein in the magnetic forces exerted by the magnet 960 can be greater than the magnetic forces exerted by the attraction plate 951. Moving the magnetic attachment closer to the selective port 918 can cause the electrical contact 928 to move closer towards the magnet 960, which in turn can cause the selective port 918 to move into an open position. The open position can be defined as the pin interior extension 968 extending out of the pin baseplate 950, which can allow the electrical contact 928 to be exposed past the surface of the securement arm 901.

In at least one example, the pin retention aperture 966 can be configured to receive the pin outer cover 948 of the selective port 918 in an open position. When the pin outer cover 948 is received, the top and bottom extension walls 962a and 962b, in combination with the top and bottom retention flanges 964a and 964b, can wrap around the pin outer cover 948 to retain the pin outer cover 948 within the pin retention aperture 966. This system of retention can be advantageous to the user of the device 100 in that the user can perform various movements without the selective port 918 losing connection with the magnetic attachment 983.

In some examples, the electrical contact 928 or the pin outer cover 948, or both, can be rotatable. This can be advantageous for the user of the device 100 in that the magnetic attachment 983 can be rotated in relation to the securement arm 901 while still holding physical retention and an electrical connection.

Any of the features, components, and/or parts, of the rim 360 including the arrangements and configurations thereof shown in FIG. 9 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 9.

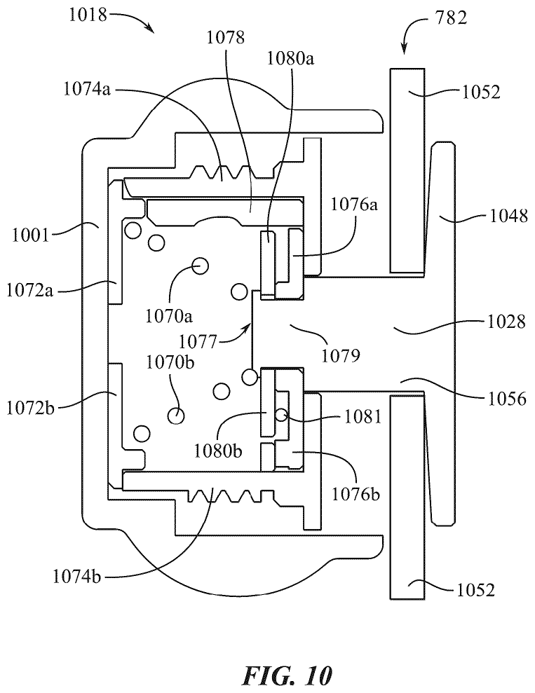

FIG. 10 shows a side view of a selective port 1018 joined to an attachment clip 1082, wherein the translatable electronic port 1018 can be manually operable between the closed and open configurations illustrated by FIGS. 6A and 6B. Referring to FIG. 10, in at least one example, the attachment clip 1082 can include a clip arm 1052, wherein the clip arm 1052 can be defined by a pin inner aperture 1056. The pin inner aperture 1056 can be configured to receive the pin outer cover 1048 and electrical contact 1028 of the selective port 1018. In one example, the clip arm 1052 can wrap around a portion of the circumference of the electrical contact 1028.

In at least one example, the selective port 1018 can be manually operable between the open and closed configurations illustrated in FIGS. 6A and 6B. According to the present disclosure, opening and closing can be done through the use of compressing springs 1070a and 1070b to extend and retract the electrical contact 1028. In one example, the user can manually manipulate the selective port 1018 into open and closed positions by pressing on top and bottom spring plates 1072a and 1072b. In one embodiment, top and bottom spring plates 1072a and 1072b can be attached to springs 1070a and 1070b, which can allow them to compress based on action from the user. The springs 1070a and 1070b can also attach to top and bottom spring forward plates 1080a and 1080b, wherein the spring forward plates 1080a and 1080b can push on a pin inner cover 1077, which can be an axial extension from the electrical contact 1028.

In one example, the top and bottom forward spring plates 1080a and 1080b can also press against top and bottom retention catches 1076a and 1076b, respectively. The spring plates 1080a, 1080b, and the retention catches 1076a and 1076b can be configured to fill the space defined between the pin inner cover 1077, the pin inner diameter 1079, and the electrical contact 1028. This can allow the electrical contact 1028 be selectively moved inside and outside of the securement arm 1001. Furthermore, the retention catch can house a retention spring 1081, which can be configured to

In one example, top and bottom pin guides 1074a and 1074b can also be housed inside the securement arm 1001. The pin guides 1074a, 1074b can act as a form of retention so the other components housed inside of the securement arm 1001 can move as designed. A guide buffer 1078 can be placed inside the selective port 1018 between the top pin guide 1074a and the top spring plate 1072a which can enable the pin guides 1074a and 1074b to move with the spring plates 1072a and 1072b when the user actuates the selective port 1018 from a closed to an open position, or vice versa.

Any of the features, components, and/or parts, of the rim 360 including the arrangements and configurations thereof shown in FIG. 10 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 10.

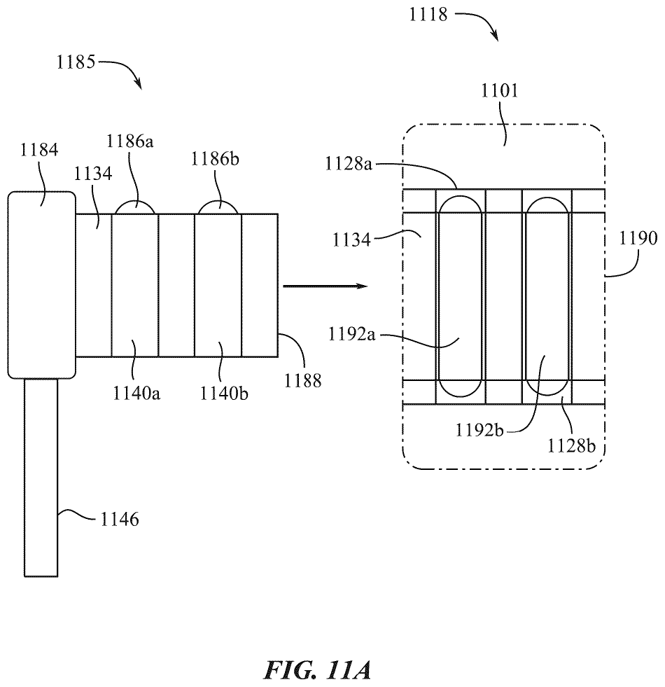

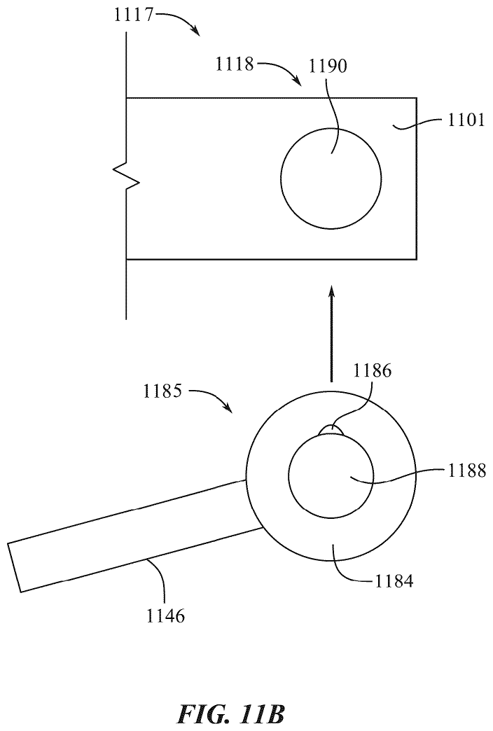

FIG. 11A illustrates a cross-sectional side-view of an axial port 1118 and a side view of an axial attachment 1185. In at least one example, the axial electrical port 1118 can be constructed or disposed at the distal tip 1117 of the securement arm 1101, where the axial port 1118 can be defined by an axial aperture 1190. In at least one example, the axial aperture 1190 can define a through-hole extending entirely through the distal tip of the securement arm 1101. Furthermore, in some examples the axial port 1118 can be configured to receive the axial attachment 1185 through the axial aperture 1190.

In various examples, the axial electrical port 1118 can include a variety of different components for the retention and connection of an axial attachment 1185. In some examples, the axial aperture 1190 can further be defined by first and second axial electrical contacts 1128a and 1128b. In some examples, the first and second axial electrical contacts 1128a and 1128b can be configured to extend partly or entirely around the circumference of the axial aperture 1190. In at least one example, ball indents 1192a and 1192b can be cut into the first and second axial electrical contacts 1128a and 1128b, where the ball indents 1192a and 1192b can also extend partly or entirely around the circumference of the axial aperture 1190.

In some examples, insulator material 1134 can be disposed between and around the electrical contacts 1128a and 1128b. The insulator material 1134 can be advantageous to the device 100 in that it can keep the charge applied to electrical contacts 1128a and 1128b from being dispersed to other parts of the device 100.

The axial attachment 1185 can include an axial base 1184, where, in at least one example, an electrical cord 1146 can be attached. In some examples, the electrical cord 1146 can be a power cord, a data cord, or a combination of both a power and data cord. An axial insert 1188 can extend from the axial base 1184, wherein the axial insert can include any number of components for electrical connection and physical retention to the axial port 1118.

In at least one example, the axial insert 1188 can include first and second exterior electrical contacts 1140a and 1140b. In some examples, the first and second exterior electrical contacts 1140a and 1140b can extend partly or entirely around the circumference of the axial insert 1188. Insulator material 1134 can also be placed between and around the first and second exterior electrical contacts 1140a and 1140b. The insulator material 1134 can be advantageous to keep the charge applied to electrical contacts 1128a and 1128b from being dispersed to the other parts of the axial attachment 1185 or the device 100.

In some examples, the axial port 1118 can be configured to receive the axial attachment 1185. Ball indents 1192a and 1192b can be configured to receive ball detents 1186a and 1186b when the axial attachment 1185 is inserted into the axial port 1118 through the axial aperture 1190. When inserted, the exterior electrical contacts 1140a and 1140b can line up with the axial electrical contacts 1128a and 1128b, wherein the ball detents 1186a and 1186b can seat or otherwise lock into the ball indents 1192a and 1192b, respectively. As noted above with reference to other examples, the ball indents 1192a-b and ball detents 1186a-b can be switched such that the axial port 1118 includes ball detents and the axial attachment includes corresponding ball indents.

When the axial attachment 1185 is inserted into the axial port 1118, the axial insert 1188 can be configured to lie flush with the surface of the securement arm 1101. This can be advantageous to the user of the device 100 in that it can prevent unwanted materials from entering into the axial aperture 1190. In some examples, the seal created between the axial insert 1188 and the securement arm 1101 can prevent moisture, such as sweat from the user, from entering the axial aperture 1190, thus keeping clear the connection between the exterior electrical contacts 1140a and 1140b and the axial electrical contacts 1128a and 1128b.

The retention system created between ball detents 1186a, 1186b and ball indents 1192a, 1192b, can allow the user to perform various movements without the axial attachment 1185 losing connection from the axial port 1118. Forces exerted from various directions can be mitigated with the use of the retention system described herein. Furthermore, the axial design of the physical connection between the ball detents 1186a and 1186b and the ball indents 1192a and 1192b can allow the axial attachment 1185 to be rotated without losing connection between the axial attachment 1185 and the axial port 1118, and without lessening the seal created between the axial insert 1188 and the securement arm 1101. For example, FIG. 11B shows a side-view of the axial port 1118 and a top-view of the axial attachment 1185. In this example, when the axial insert 1188 is placed into the axial aperture 1190, the axial attachment 1185 can rotate around the circumference of the axial aperture 1190, which can allow the cord 1146 to be oriented in a direction most desirable by the user.

In at least one example, the indents 1192a-b disposed in the axial port 1118 and the detents 1186a-b disposed in the axial attachment 1185 can be switched. For example, ball indents can be disposed in the electronic port 1118 and indents can be disposed in the axial attachment 1185. In this example, the axial attachment 1185 can still be rotated around the circumference of the axial aperture 1190 of the electronic port 1118. This can enable either the axial attachment 1185 or the electronic port 1118 to have a clean look free of extended retention devices, which can further enhance the overall aesthetic of the head-mountable device. In some examples, switching the location of the indents and detents can also avoid further snagging of unwanted materials when attaching the axial attachment 1185 to the electronic port 1118.

Any of the features, components, and/or parts, of the rim 360 including the arrangements and configurations thereof shown in FIGS. 11A and 11B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 11A and 11B.

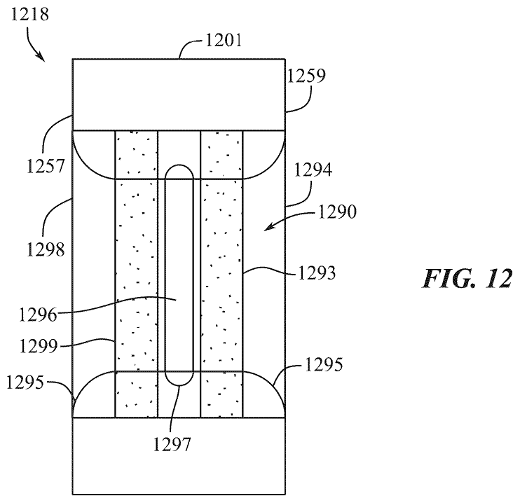

FIG. 12 shows a cross-sectional side-view of the electronic port 1218 in accordance with one or more examples of the present disclosure. In at least one example, the securement arm 1201 includes a first surface 1257 and a second surface 1259 opposite the first surface 1257. In some examples, the length between the first surface 1257 and the second surface 1259 can define the thickness of the securement arm 1201. Additionally, a through-hole 1290 can be defined by the securement arm 1201 and disposed in the electronic port 1218. The through-hole 1290 can be configured to extend the entire thickness of the securement arm 1201. For example, the through-hole 1290 can extend from the first surface 1257 to the second surface 1259, thereby creating a hole through the thickness of the securement arm 1201. In some examples, the through-hole 1290 can be defined by an inner surface of the securement arm 1201.

The securement arm 1201 can be in contact with a user's head or hair during use and the electronic port 1218 can be utilized throughout the life of the electronic device. As such, the electronic port 1218 can include features that are minimally intrusive to the user's head and hair while still being visually appealing. Thus, in at least one example, the thickness of the securement arm 1201, as well as the thickness of the through-hole 1290 of the electronic port 1218, can be less than about 8 mm. In other examples, the thickness of the securement arm 1201, and the thickness of the through-hole 1290 of the electronic port 1218, can be less than about 6 mm. In further examples, the thickness of the securement arm 1201 can be less than about 4 mm. Due to the small thickness of the securement arm 1201 and the resulting through-hole 1290 of the electronic port 1218, examples of the electronic port 1218 described herein can include a number of features to mitigate electrical shorting from moisture entering the through-hole 1290, including moisture from the user's sweat or weather related moisture such as rain and snow, as well as mitigating wear and tear, corrosion, and other damage over extended and repeated use in many different environments, even while maintaining the thin profile and aesthetically pleasing design described herein.

In at least one example, the electronic port 1218 can define the through-hole 1290. For example, various electrical contacts can be disposed in the through-hole 1290. In one example, a first electrical contact 1298 can define the inner surface of the through-hole 1290. Additionally, a second electrical contact 1296 and a third electrical contact 1294 can further define the inner surface of the through-hole 1290. In at least one example, the first, second, and third electrical contacts 1298, 1296, and 1294 can be configured to wrap around a circumference of the through-hole 1290. Additionally, the electrical contacts 1298, 1296, and 1294 can be constructed out of a material that can conduct electricity. This can enable the contacts 1298, 1296, and 1294 to connect to an exterior plug or other device for charging, data transfer, or other related purposes.

In some examples, the second electrical contact 1296 can be disposed between both the first electrical contact 1298 and the third electrical contact 1294. In at least one example, a first insulating portion 1299 can be disposed between the first electrical contact 1298 and the second electrical contact 1296. Similarly, a second insulating portion 1293 can be disposed between the second electrical contact 1296 and the third electrical contact 1294. The first and second insulating portions 1299 and 1293 can be constructed out of a different material than the electrical contacts. In at least one example, the material making up the first and second insulating portions 1299 and 1293 can be a material that restricts the flow of electricity. This can be advantageous to the electronic port 1218 in that electrical charges directed to certain electrical contacts will not bleed into different electrical contacts.

Additionally, in some examples the first and third electrical contacts 1298 and 1294 can include a beveled edge 1295 around the outer edge of their circumferences. These beveled edges 1295 can be rounded so that the ends of the through-hole are not sharp edges. Additionally or alternatively, the beveled edges 1295 of the first and third electrical contacts 1298 and 1294 can be configured so that the inner surface of the through-hole 1290 can merge into the surfaces 1257, 1259 of the securement arm 1201 without any hard stops or edges. This can be advantageous in that an external attachment can be more easily inserted into the through-hole 1290. For example, with the beveled edges 1295, an external attachment can be inserted from a variety of angles without getting caught or hung up on an abrupt edge. External attachments inserted into the through-hole 1290 at different angles can right themselves as they are further inserted into the securement arm 1201. This can make the insertion of an external attachment easier and more convenient for a user.

In at least one example, the second electrical contact 1296 can include an inner indent 1297. The inner indent 1297 can be an indentation that extends around the circumference of the second electrical contact 1296. In some examples, the inner indent 1297 can retain an external attachment. For example, an external attachment can be configured to include a type of detent that can fit into the inner indent 1297, thus creating retention between the securement arm 1201 and an external attachment.

In at least one example of the present disclosure, the first electrical contact 1298 and the third electrical contact 1294 can be electrically coupled to an electrical ground of the head-mountable device, while the second electrical contact 1296 can be electrically coupled to other components of the head-mountable device. For example, the second electrical contact 1296 can be electrically coupled to a battery or a processing unit. In these examples, the second electrical contact 1296 can be configured to provide charging and/or data transmission capabilities between an external source and the head-mountable device.

Any of the features, components, and/or parts, of the rim 360 including the arrangements and configurations thereof shown in FIG. 12 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 12.

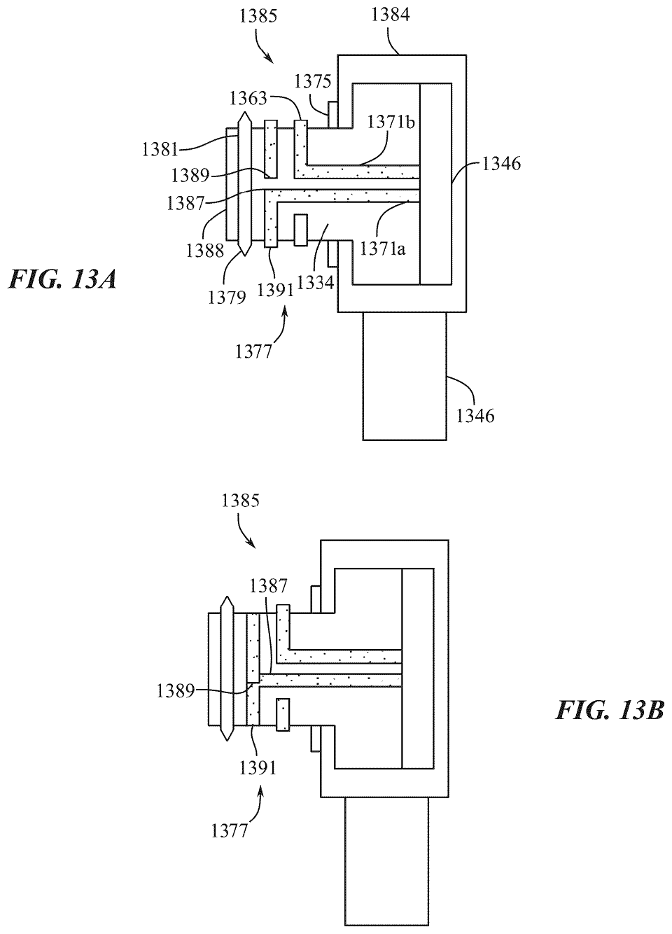

FIGS. 13A and 13B show another example of an external attachment for the head-mountable devices described herein. FIG. 13A shows a cross-sectional side-view of an external attachment to the head-mountable device in accordance with one or more examples of the present disclosure. In at least on example, the external attachment can be a plug 1385, where the plug 1385 can be configured to attach to the electronic port 1218 illustrated in FIG. 12. In some examples, the plug 1385 can include an insertion portion 1377, where the insertion portion 1377 can extend from the axial base 1384 of the plug 1385. In at least one example, the insertion portion 1377 can include a distal end 1388 and a proximal end 1334. In at least one example, the distal end 1388 can be opposite the proximal end 1334, where the proximal end 1334 can be proximal to the axial base 1384 and the distal end 1388 can be distal to the axial base 1384. Additionally, the insertion portion 1377 of the plug 1385 can define an axial length that can be equal to or less than the thickness of the securement arm as described in FIG. 12. In this way, the insertion portion 1377 of the plug 1385 can extend through the through-hole 1290 and can form a flush surface between either the first or second surfaces 1257, 1259 of the securement arm 1201 (depending on which side the plug 1385 is inserted) and the distal end 1388.

In at least one example, a first conductive plug contact 1391 and a second conductive plug contact 1363 can be disposed between the proximal and distal ends 1334, 1388 of the insertion portion 1377. In some examples, the first conductive plug contact 1391 can be disposed between the second conductive plug contact 1363 and the distal end 1388 of the insertion portion 1377. In some examples, the first conductive plug contact 1391 can be disposed distal to the second conductive plug contact 1363. Similarly, the second conductive plug contact 1363 can be disposed between the first conductive plug contact 1391 and the proximal end 1334 of the insertion portion 1377. In some examples, the second conductive plug contact 1363 can be disposed proximal of the first conductive plug contact 1391. In at least one example, the first and second conductive plug contacts 1391 and 1363 can define an external surface of the insertion portion 1377.

In at least one example, the first and second conductive plug contacts 1391 and 1363 can be constructed out of a conductive material. In some examples, the material of the first and second conductive plug contacts 1391 and 1363 can be different from the material of the insertion portion 1377. In at least one example, the material of the insertion portion 1377 can be an insulating material, such that electricity cannot propagate through and/or across the insertion portion 1377 or other regions of the plug 1385. This can insulate the first and second conductive plug contacts 1391 and 1363 from each other. For example, the insertion portion 1377 being a different material than the contacts can further separate the electrical charge on one contact from another. This can enable the first and second conductive plug contacts 1391 and 1363 to distribute separate electrical charges to different types of electrical ports, such as the one shown in FIG. 12.

In another example, the first and second conductive plug contacts 1391 and 1363 can be an expandable ring that can circle the insertion portion 1377. For example, the first conductive plug contact 1391 can include a first terminal end 1389 and a second terminal end 1387. In at least one example, the first terminal end 1389 can be one end of the expandable ring created by the first conductive plug contact 1391. Likewise, the second terminal end 1387 can be the other end of the expandable ring created by the first conductive plug contact 1391. In some examples, the expandable ring does not wrap entirely around the circumference of the insertion portion 1377 of the plug 1385. In this example, the first terminal end 1389 does not reach the second terminal end 1387, which can create a gap between the terminal ends 1389 and 1387. In at least one example, the expandable ring of second conductive plug contact 1363 can also include first and second terminal ends similar to that of the first conductive plug contact 1391. Furthermore, it can also be noted that the second conductive plug contact 1363 can have a gap between its first and second terminal ends like unto the first conductive plug contact.

In some examples, the first and second conductive plug contacts 1391 and 1363 can be configured to protrude above the surface of the insertion portion 1377. As shown in FIG. 13A, the outer surface of both the first and second conductive plug contacts 1391 and 1363 can extend radially from the plug 1385. This can enable the first and second conductive plug contacts 1391 and 1363 to more readily engage the electrical contacts disposed in the electrical port as shown in FIG. 12. The ring configurations of the first and second conductive plug contacts 1391, 1363 combined with the material stiffness or modulus of the contacts 1391, 1363 and the protrusion of the plug contacts 1391, 1363 above the external surface of the insertion portion 1377 can form a spring biased contact against the inner surface of the through-hole 1290 of the corresponding electronic port 1218 between the first and second conductive plug contacts 1391, 1363 and respective electrical contacts 1298, 1296, 1294 of the electronic port 1218 when the insertion portion 1377 of the plug 1385 is inserted into the through-hole 1290.

In at least one example, the plug 1385 can further include a cable 1346, where the cable 1346 can be a power cable, a charging cable, and/or a cable capable of transmitting data. In some examples, the cable 1346 can be attached to the plug 1385. Additionally, the cable 1346 can extend through the axial base 1384 of the plug 1385. This can enable different components of the plug 1385 to access the electrical charge provided from the cable 1346.

In some examples of the present disclosure, the first and second conductive plug contacts 1391 and 1363 can include respective elongated portions 1371a, 1371b, where the elongated portion can extend through the insertion portion 1377 of the plug 1385. In at least one example, the elongated portions 1371a-b can connect to the cable 1346. In this manner, the first and second conductive plug contacts 1391 and 1363 can be electrically coupled to the cable 1346. This can enable the plug 1385 to direct electric charges from an external source to the head-mountable device when inserted into an electrical port. In some examples, the first conductive plug contact 1391 can be connected to a power source via the cable 1346. Additionally, the second conductive plug contact 1363 can be connected to an electrical ground via the cable 1346.

In at least one example, the plug 1385 can include a wiper 1381. In some examples, the wiper 1381 can be a ring attached to the insertion portion 1377 of the plug 1385. The wiper 1381 can be disposed between the distal end 1388 and the first conductive plug contact 1391. In other examples, the wiper 1381 can be disposed at the distal end 1388 of the plug 1385. Furthermore, the wiper 1381 can be a different material than the insertion portion 1377, where the material of the wiper 1381 can be a material softer than the material of the insertion portion 1377. For example, the wiper 1381 can be constructed out of a soft plastic, rubber, textile, or other kind of soft material. In some examples, the wiper 1381 is formed of a material with a lower Young's modulus than the material forming the insertion portion 1377.

In some examples, the wiper 1381 can extend radially from the surface of the insertion portion 1377. Furthermore, the ring of the wiper 1381 can taper to a thinner width as it extends from the surface of the insertion portion 1377. For example, the farther the wiper 1381 extends, the thinner it can taper. This can be beneficial in that in some examples, the wiper can be more flexible the thinner it is. In some examples, the wiper 1381 can retain a more rigid structure near the surface of the insertion portion 1377. As the wiper 1381 tapers as it extends farther from the external radial surface of the insertion portion 1377, the flexibility of the wiper 1381 can increase proportionally to the thickness of the wiper 1381. For example, the wiper tip 1379 can be more flexible than the base of the wiper 1381. This can increase the overall flexibility of the wiper 1381.

In at least one example of the present disclosure, the plug 1385 can include a proximal seal 1375. The proximal seal 1375 can be disposed at the proximal end 1334 of the plug 1385. In this position, the first and second conductive plug contacts 1391 and 1363 can be disposed between the wiper 1381 and the proximal seal 1375. Additionally, the proximal seal 1375 can be configured to extend radially outward from and around the outer surface of the plug 1385. For example, the proximal seal 1375 can wrap around the circumference of the insertion portion 1377, as shown in FIG. 13A.

In some examples, the proximal seal 1375 can be a different material than the plug 1385. In at least one example, the material of the proximal seal 1375 can be similar to the material of the wiper 1381 in that the material of the proximal seal 1375 can be softer, or have a lower Young's modulus, than the material of the plug 1385. In at least one example, the proximal seal 1375 can be constructed out of a material that can compress. For example, the proximal seal 1375 can be constructed from soft plastics, rubber, foam, or other pliable material. During use, the proximal seal 1375 can be compressed against a surface 1257, 1259 of the securement arm 1201 to form a seal, preventing moisture and debris from entering the electronic port 1218.

FIG. 13B shows another cross-sectional side-view of the plug 1385 in accordance with one or more examples of the present disclosure. In at least one example, the first and second conductive plug contacts 1391 and 1363 can move such that the first terminal end 1389 of the expandable ring can overlap with the second terminal end 1387 of the expandable ring. This can enable either the first or second conductive plug contacts 1391 or 1363 to be compressed.

FIG. 13B shows an example of the compression of the first conductive plug contact 1391. In this example, the expandable ring is compressed such that the first terminal end 1387 overlaps the second terminal end 1389. In doing so, the overall area of the expandable ring is compressed. This can further enable the circumference of the expandable ring to decrease. When the expandable ring is compressed, the conductive contact can recede into the insertion portion 1377 of the plug 1385. In this example, the outer surface of the expandable ring can sit flush with the outer surface of the insertion portion 1377. This can differ from the initial position of the expandable ring (as shown in FIG. 13A) in that the expandable ring no longer extends radially above the surface of the insertion portion 1377.

In some examples, external pressure can be applied to the first and second conductive plug contacts 1391 and 1363. When this external pressure is applied, the expandable rings of either the first, second or both conductive plug contacts 1391 and 1363 can recede into the insertion portion 1377 of the plug 1385. When the external pressure is removed from the contacts, the expandable rings can resume their original configurations, where the expandable rings can again increase their circumference and radially extend such that the outside surface of the expandable rings protrudes above the surface of the insertion portion 1377. In this manner, the shape of the expandable rings can be retained by a spring force.

In at least one example, the spring force of the expandable rings of both the first and second conductive plug contacts 1391 and 1363 can define a retention feature of the plug 1385. While not compressed by an external force, the expandable rings can protrude radially past the surface of the insertion portion 1377 of the plug 1385. In this configuration, the expandable rings can be detents for the plug 1385. For example, while the expandable ring of either the first or second conductive plug contacts 1391 or 1363 is not compressed, the protruded portion of the expanded ring can be configured to resist movements in various directions until the expandable ring is compressed.

Any of the features, components, and/or parts, of the rim 360 including the arrangements and configurations thereof shown in FIGS. 13A-13B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 13A-13B.

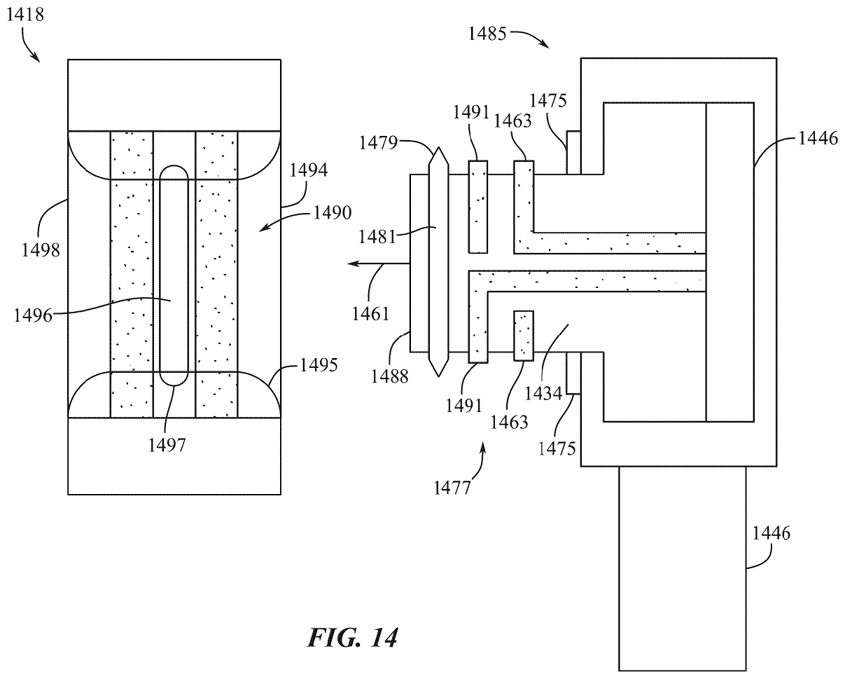

The following discussion illustrates the interplay between the external attachment described FIG. 13A and the electronic port described in FIG. 12. FIG. 14 shows a cross-sectional side-view of the plug 1485 and the electronic port 1418 in accordance with one or more examples of the present disclosure. In at least one example, the plug 1485 can be inserted into the electronic port 1418. In some examples, the insertion portion 1477 of the plug 1485 can be configured to be inserted into the electronic port 1418 via the through-hole 1490. In at least one example, the plug 1485 can be inserted into the through-hole 1490 as noted by the direction arrow 1461. In this manner, the distal end 1488 of the plug 1485 can be inserted first into the through-hole 1490.

In some examples of the present disclosure, the wiper 1481 can extend radially from the insertion portion 1477 of the plug 1485 such that the radius of the wiper 1481 can be larger than the radius of the through-hole 1490. In this example, when the insertion portion 1477 is inserted into the through-hole, the wiper 1481 can bend in order to pass through the through-hole 1490. During insertion, the wiper tip 1479 can flex and drag across the inner surface of the through-hole 1490.

In at least one example, as the wiper 1481 drags across the inner surface of the through-hole 1490, the wiper 1481 can wipe the inner surface of the through-hole 1490. This can remove undesirable materials and moisture caught in the electronic port 1418. For example, dust, grime, dirt, and other solid particles can cover the inner surface of the through-hole 1490 over time. When the plug 1485 is pushed into the through-hole 1490, the wiper 1481 can remove these unwanted substances from within the electronic port 1418.

In some examples, when the plug 1485 is fully inserted into the electronic port 1418, the wiper 1481 can exit the side of the through-hole 1490 opposite from which it entered. In this event, the wiper 1481 can revert back to its original configuration or shape, where the original configuration of the wiper 1481 does not bend or flex, but rather holds a more rigid form. In at least one example, when the wiper 1481 reverts back to its original configuration, the wiper 1481 can extend radially past the opening of the through-hole 1490 and create a seal on one end of the through-hole 1490. The seal created by the wiper 1481 can prevent undesirable materials from entering the through-hole 1490 while the plug 1485 is inserted into the electronic port 1418.

In some examples, the proximal seal 1475 can be configured to seal the proximal end 1434 of the insertion portion 1477 when the plug 1485 is fully seated in the through-hole 1490 of the electronic port 1418. For example, when the insertion portion 1477 is fully extended into the through-hole 1490, the proximal seal 1475 can compress against the surface of the electronic port 1418. In one example, the proximal seal 1475 can compress against either the third electrical contact 1494 or the first electrical contact 1498, depending on which direction the plug 1485 is inserted into the electronic port 1418. This can enable the components disposed in the plug 1485 and the electronic port 1418 to be shielded from external substances. In at least one example, the wiper 1481 and the proximal seal 1475 can be configured to prevent substances from entering into the through-hole 1490 from either direction.

In at least one example, as the insertion portion 1477 of the plug 1485 is inserted into the through-hole 1490, the radius of the expandable rings of the first and second conductive plug contacts 1491 and 1463 can be greater than the radius of the through-hole 1490. This can enable the first conductive plug contact 1491 to come into contact with the beveled edge 1495 of the third electrical contact 1494 as the insertion portion 1477 is inserted into the through-hole 1490. When pressed together, the beveled edge 1495 can exert a downward force on the expandable ring of the first conductive plug contact 1491. In some examples, this downward force can cause the expandable ring to compress such that the outer surface of the expandable ring can sit flush with the surface of the insertion portion 1477.

In some examples, as the plug 1485 is further inserted into the electronic port 1418, the second conductive plug contact 1463 can come into contact with the beveled edge 1495. The beveled edge 1495 can exert a downward force on the expandable ring of the second conductive plug contact 1463 which can cause the expandable ring of the second conductive plug contact 1462 to sit flush with the surface of the insertion portion 1477. With both the expandable rings of the first and second conductive plug contacts 1491 and 1463 compressed, the insertion portion 1477 of the plug 1485 can be moved into the through-hole 1490.

In at least one example, various components of the plug 1485 can connect with components disposed within the electronic port 1418. In some examples, the first conductive plug contact 1491 can be configured to contact the second electrical contact 1496. Similarly, the second conductive plug contact 1463 can be configured to contact the third electrical contact 1494. In this manner, the second electrical contact 1496 can be connected to a power source via the first conductive plug contact 1491 and the cable 1446. Likewise, the third electrical contact 1494 can be connected to an electrical ground via the second conductive plug contact 1463 and the cable 1446.

In some examples of the present disclosure, the plug 1485 can be inserted into the electronic port 1418 from the opposite side. In this example, the insertion portion 1477 can be seated in the through-hole 1490 such that the wiper 1481 covers the outside of the third electrical contact 1494 and the second conductive plug contact 1463 can be connected to the first electrical contact 1498, therefore connecting the electronic port 1418 to an electrical ground through the first electrical contact 1498 instead of the third electrical contact 1494. In this example, first conductive plug contact 1491 can still be connected to the second electrical contact 1496. This can facilitate the plug 1485 being inserted from both sides of the through-hole 1490 while maintaining electrical connections between both power and ground sources. The ability to insert the plug 1485 from either direction can be convenient for a user in that they can further utilize an electronic connector in a manner convenient to their needs.

In at least one example, the expandable ring of the first conductive plug contact 1491 can define a securement feature to resist extraction of the insertion portion 1477 of the plug 1485 out of the through-hole 1490 when the insertion portion 1477 is seated in the through-hole 1490. For example, when the insertion portion 1477 is fully extended into the through-hole 1490 of the electronic port 1418, the first conductive plug contact 1491 can be axially in line with the second electrical contact 1496. When in this position, the expandable ring of the first conductive plug contact 1491 can expand and fill the indent 1497 set into the circumference of the second electrical contact 1496. In at least one example, the expansion of the expandable ring of the first conductive plug contact 1491 can secure the plug 1485 to the electronic port 1418, keeping the plug 1485 secured to the electronic port 1418 without falling out or extracting during undesirable times.

Any of the features, components, and/or parts, of the rim 360 including the arrangements and configurations thereof shown in FIG. 14 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 14.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An electronic device, comprising:
a frame;
a window secured to the frame;
a waveguide configured to direct light displayed at the window; and
a securement arm including an electronic port electrically coupled to the waveguide, the electronic port comprising:
a through-hole defined by an inner surface of the securement arm;
a first electrical contact defining the inner surface; and
a second electrical contact defining the inner surface.

2. The electronic device of claim 1, wherein:
the securement arm includes a first surface and a second surface opposite the first surface;
the securement arm includes a thickness defined between the first surface and the second surface; and
the through-hole extends entirely through the thickness of the securement arm.

3. The electronic device of claim 2, wherein the thickness is less than about 6 mm.

4. The electronic device of claim 1, wherein the electronic port further comprises:
a third electrical contact defining the inner surface;
a first insulating portion defining the inner surface between the first electrical contact and the second electrical contact; and
a second insulating portion defining the inner surface between the second electrical contact and the third electrical contact.

5. The electronic device of claim 4, wherein:
the second electrical contact is positioned between the first electrical contact and the third electrical contact; and
the first electrical contact and the third electrical contact are electrically coupled to an electrical ground of the device.

6. The electronic device of claim 1, wherein the first electrical contact comprises an expandable ring having a first terminal end and a second terminal end opposite the first terminal end.

7. The electronic device of claim 6, wherein the first terminal end overlaps the second terminal end to define an overlap region of the expandable ring.

8. The electronic device of claim 1, wherein:
the securement arm comprises:
a proximal end secured to the frame; and
a distal end opposite the proximal end; and
the electronic port is disposed at the distal end.

9. The electronic device of claim 8, wherein the electronic port is configured to be positioned behind an ear of a user when the user dons the electronic device.

10. An electronic connection system for an electronic device, comprising:
an electronic port comprising:
a through-hole defined by the electronic device, the through-hole extending through a thickness of the electronic device; and
a conductive port contact defining the through-hole; and
a plug configured to extend into the through-hole, the plug comprising:
an insertion portion configured to extend into the through-hole, the insertion portion including a distal end and a proximal end opposite the distal end;
a conductive plug contact disposed between the distal end and the proximal end and configured to contact the conductive port contact when the insertion portion extends into the through-hole; and
a cable secured to the proximal end and electrically coupled to the conductive plug contact.

11. The electronic connection system of claim 10, wherein the plug contact comprises a securement feature configured to resist extraction of the insertion portion out of the through-hole when the insertion portion is extended into the through-hole.

12. The electronic connection system of claim 10, wherein the insertion portion defines an axial length equal to or less than the thickness.

13. The electronic connection system of claim 10, wherein:
the plug contact is a first plug contact;
the plug further comprises a second plug contact disposed between the first plug contact and the distal end;
the port contact is a first port contact; and
the electronic port further comprises:
a second port contact; and
a third port contact, the first port contact disposed between the second port contact and the third port contact.

14. The electronic connection system of claim 13, wherein the second plug contact is configured to contact the second port contact or the third port contact when the insertion portion extends into the through-hole.

15. An electronic plug, comprising:
an insertion portion including:
a distal end;
a proximal end opposite the distal end; and
an outer surface extending between the distal end and the proximal end;
a conductive cable secured to the proximal end;
a proximal electrical contact coupled to the conductive cable and defining the outer surface;
a distal electrical contact coupled to the conductive cable and defining the outer surface, the distal electrical contact biased radially outward, the proximal electrical contact disposed between the distal electrical contact and the proximal end; and
a wiper disposed at the distal end and extending radially outward from and around the outer surface.

16. The electronic plug of claim 15, wherein the second electrical contact forms a ring comprising:
a first terminal end electrically coupled to the conductive cable; and
a second terminal end separated from the first terminal end to define a gap.

17. The electronic plug of claim 15, wherein:
the insertion portion comprises a first material; and
the wiper comprises a ring including a second material softer than the first material.

18. The electronic plug of claim 17, wherein the ring tapers thinner away from the outer surface.

19. The electronic plug of claim 15, wherein:
the proximal electrical contact is configured to be connected to an electrical ground via the conductive cable; and
the distal electrical contact is configured to be connected to a power source via the conductive cable.

20. The electronic plug of claim 15, further comprising a seal disposed at the proximal end and extending radially outward from and around the outer surface, wherein the proximal electrical contact and the distal electrical contact are disposed between the seal and the wiper.
